(19) United States
(12) Patent Application Publication
(10) Pub. No.: US 2011/0189018 A1
(43) Pub. Date: Aug. 4, 2011

(54) PROPELLER

(75) Inventor: Conny Thyberg, Ockero (SE)

(73) Assignee: BERG PROPULSION TECHNOLOGY AB, Ockero (SE)

(21) Appl. No.: 13/048,363

(22) Filed: Mar. 15, 2011

Related U.S. Application Data
(63) Continuation of application No. PCT/EP2009/061789, filed on Sep. 11, 2009.

(30) Foreign Application Priority Data
Sep. 22, 2008 (SE) 0802012-5

(51) Int. Cl. F01D 7/00; B23P 11/00

(52) U.S. Cl. 416/151; 29/428

(57) ABSTRACT

The present invention relates to a propeller comprising a boss with a boss diameter and at least one propeller blade. The propeller further comprises an adjusting member, adapted to be displaced along a first dimension, and a transformation arrangement connecting the adjusting member to the propeller blade such that a displacement, in the first dimension, of the adjusting member results in a change in the pitch of the propeller blade. The transformation arrangement comprises a slot comprising a slot portion with a slot center extending in a slot extension direction which direction is arcuate with a radius of curvature. The transformation arrangement further comprises a control element slidably engaged with at least the slot portion.

### TECHNICAL FIELD

The present invention relates to a propeller comprising a boss with a boss diameter and at least one propeller blade. The propeller further comprises an adjusting member, adapted to be displaced along a first dimension, and a transformation arrangement connecting the adjusting member to the propeller blade such that a displacement, in the first dimension, of the adjusting member results in a change in the pitch of the propeller blade. The transformation arrangement comprises a slot comprising a slot portion with a slot centre extending in a slot extension direction which direction is arcuate with a radius of curvature. The transformation arrangement further comprises a control element slidably engaged with at least the slot portion.

### BACKGROUND OF THE INVENTION

Floating vessels, in particular cargo vessels and supply vessels, of today are generally furnished with a propulsion system which includes an adjustable propeller. To this end, the propeller includes at least one propeller blade, but often a plurality of propeller blades, wherein the pitch of each one of the aforesaid blades is controlled by a servo arrangement. The servo arrangement generally is a hydraulic arrangement the fluid chambers and piston of which generally are located in the boss of the propeller.

The piston of the aforesaid servo arrangement is generally connected to an adjusting member such that the adjusting member is adapted to be displaced in a longitudinal direction. Since the fluid chambers of the hydraulic arrangement may be subjected to high pressures, the adjusting member is preferably located outside the fluid chambers. The longitudinal displacement of the adjusting member is in turn transformed into a rotation—i.e. a change in pitch—of a propeller blade by means of a transformation arrangement. Normally, the transformation arrangement includes a control element, such as a pin, which is rigidly connected to the propeller blade and which engages with a slot in the adjusting member, which slot extends in a rectilinear slot extension direction which is substantially perpendicular to the longitudinal direction.

Although the propeller as presented hereinabove generally is appropriate for many marine applications, there are some shortcomings associated with such propellers. For instance, it is generally difficult to obtain a feathering position of the propeller blades—i.e. a position with minimum drag of the blades. This is since a feathering position requires a relatively large displacement, in the slot extension direction, of the control member at the same time as the control member is slidably engaged with the slot which may result in that the control member may adhere to the structure delimiting the slot.

In particular, the possibility of having propellers which are adapted to be put in a feathering position is desired for vessels provided with at least two propellers—a propeller system with exactly two propellers is sometimes referred to as a twin propeller system—wherein each one of the propellers is connected to an individual machine room.

In order to reduce the risk of the control member adhering to the slot, prior art solutions, such as the ones disclosed in the documents GB821824, DE 3321968 and U.S. Pat. No. 5,464,324 teaches that the slot may be arcuate. By the provision of an arcuate slot, contact forces imparted on the control element from the slot are not perpendicular to the displacement direction of the control element when the adjusting member is displaced along the first dimension. However, the provision of the arcuate slot will in turn require that the length of the stroke of the adjusting member is increased—this is since the arcuate slot will provide for that a certain displacement in the first dimension of the adjusting member results in a smaller displacement in the first dimension of the control element—which in turn introduces the need for an increase in the size of the propeller hub, which increase generally is undesired.

As may be realized from the above, there is a need for improvements of the prior art adjustable propeller arrangements, in particular as regards prior art transformation arrangements including an arcuate slot and a control member.

### SUMMARY OF THE INVENTION

A first object of the present invention is to provide a propeller the propeller blades of which may be positioned in a feathering position.

A second object of the present invention is to provide a propeller the propeller blades of which may be positioned in a feathering position as well as a reverse propulsion position by only adjusting the pitch of the propeller blades.

A third object of the present invention is to provide a propeller wherein the pitch of the propeller blades may be altered by the use of a transformation arrangement comprising a slot and a control member, wherein the risk of the control member adhering to the control member, during a change in the pitch, may be kept low at the same time as the size of the propeller hub is kept appropriately small.

A fourth object of the present invention is to provide a propeller wherein the pitch of the propeller blades may be altered by the use of a transformation arrangement, wherein the transformation arrangement imparts an appropriately high torque—even when the propeller blade is close to a feathering position—on the propeller blade or blades when the pitch of the propeller blade(s) is to be changed.

At least one of the above objects is solved by a distribution system according to claim 1.

As such, the present invention relates to a propeller comprising a boss with a boss diameter and at least one propeller blade. The propeller further comprises an adjusting member, adapted to be displaced along a first dimension, and a transformation arrangement connecting the adjusting member to the propeller blade such that a displacement, in the first dimension, of the adjusting member results in a change in the pitch of the propeller blade. The transformation arrangement comprises a slot comprising a slot portion with a slot centre extending in a slot extension direction which direction is arcuate with a radius of curvature. The transformation arrangement further comprises a control element slidably engaged with at least the slot portion.

According to the present invention, the radius of curvature is within the range of 0.2 to 0.7 times the boss diameter.

Since the radius of curvature is within the range of 0.2 to 0.7 times the boss diameter, the risk of the control member adhering to the slot is kept low. At the same time, using a radius of curvature in the above specified region provides for that the propeller blade of the propeller may be adapted to be positioned in a feathering position as well as a backward—or astern—position without the need of a large hub.

Moreover, the inventors of the present invention have realized that the interval as presented hereinabove as regards the radius of curvature will result in that when the propeller blade is to be positioned in a feathering position, the transformation arrangement will impart an appropriately high torque on the propeller blade even when the propeller blade is close to the feathering position, which ensures that the propeller blade may be positioned in a feathering position in an efficient manner.

As used herein, the expression “slot” relates to any guide means comprising two substantially parallel extending guides. As may be realized by a person skilled in the art, the two guides may be obtained in a plurality of ways, for instance by attaching two rails parallel to one another on a work piece and/or by cutting an elongate groove in the work piece.

In a preferred embodiment of the present invention, the radius of curvature is within the range of 0.4 to 0.6, preferably within the range of 0.45 to 0.55, times the boss diameter.

According to a further embodiment of the present invention, the propeller comprises a servo located in the boss. The servo comprises a piston which is displaceable along the first dimension. The piston is rigidly connected to the adjusting member.

According to a further embodiment of the present invention, the control element comprises a block and a pin, the block comprising a block opening and being slidably engaged with the slot, the pin engaging with the block opening. This is preferable, since the two purposes of the control element—namely to be slidable in the slot and to transmit loads from the adjusting member to the propeller blade—may be split up into two components. As such, the block may be designed in order to provide appropriate sliding characteristics whereas the pin may be designed so as to provide an appropriate strength.

According to a further embodiment of the present invention, the slot is associated with the adjusting member and at least a portion of the control element is rigidly connected to the propeller blade.

According to another embodiment of the present invention, the adjusting member comprises a piston rod and a piston rod head. The piston rod is fixedly attached to the piston and the piston rod head is fixedly attached to the piston rod. The slot is provided on the piston rod head.

According to a further embodiment of the present invention, the piston rod head comprises a first piston rod head member and a second piston rod head member wherein each one of the first and second piston rod head members comprises a portion of the slot and the first and second rod head member abut against each other in an abutment plane which extends substantially perpendicularly to the first dimension. With a piston rod head according to the above, the assembling of the propeller is facilitated.

According to another embodiment of the present invention, the adjusting member comprises a substantially rectangular engagement region comprising a first, second, third and fourth edge. The first and third edges are located on opposite sides of the engagement region and extend substantially parallel to the longitudinal dimension. The second and fourth edges are located on opposite sides of the engagement region and extend substantially transversal to the longitudinal dimension. The slot extends in the engagement region from the first edge to the second edge.

According to a further embodiment of the present invention, the slot extends in a slot extension direction from the first edge. The slot has a width extending perpendicularly to the slot extension direction. The slot comprises a first slot portion and a second slot portion wherein the second slot portion is located downstream of the first slot portion in the slot extension direction. The first slot portion has a first slot width and the second slot portion has a second slot width such that the second slot portion is adapted to accommodate at least one component of the control element. The second slot may preferably be used for facilitating the assembling of the propeller.

According to a further embodiment of the present invention, the boss comprises a cavity in which at least a portion of the adjusting member is located. The propeller further comprises an inlet duct and an outlet duct which ducts both are in fluid communication with the cavity. The inlet duct and the outlet duct are interconnected outside the boss for circulating a lubrication fluid through the cavity.

According to another embodiment of the present invention, the propeller comprises a plurality of propeller blades and the adjusting member is provided with a plurality of slots. Each one of the plurality of propeller blades are provided with a control element engaging with a corresponding slot.

A second aspect of the invention relates to a vessel which comprises a propeller according to the first aspect of the present invention.

### BRIEF DESCRIPTION OF THE DRAWINGS

The present invention will hereinafter be further explained by means of non-limiting examples with reference to the appended figures wherein:

FIG. 1 illustrates a partial cross section of a side view of an embodiment of a propeller of the present invention;

FIG. 2 illustrates a propeller blade—as well as an associated blade root—of the FIG. 1 propeller;

FIG. 3 is a perspective view of the adjusting member of the FIG. 1 propeller;

FIG. 4 is a top view of the adjusting member of the FIG. 1 propeller;

FIG. 5A-5C is a schematic top view illustrating a transformation arrangement in various pitch adjusting positions;

FIG. 6 is a diagram illustrating the torque imparted on a propeller blade as a function of a pitch angle;

FIG. 7 is a top view of the adjusting member of the FIG. 1 propeller;

FIG. 8 is a top view of a part of the FIG. 7 adjusting member during an assembly procedure, and

FIG. 9 is a top view of a part of the FIG. 7 adjusting member after the assembly procedure.

### DETAILED DESCRIPTION OF PREFERRED EMBODIMENTS

The invention will be described using examples of embodiments. It should however be realized that the embodiments are included in order to explain principles of the invention and not to limit the scope of the invention, defined by the appended claims.

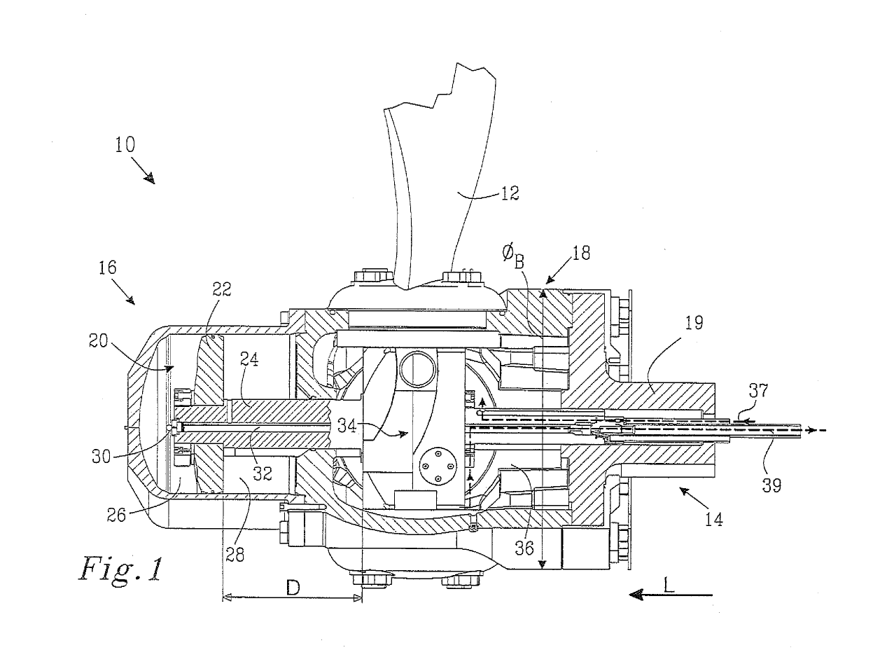

FIG. 1 illustrates a side view of a cut away propeller 10 according to an embodiment of the present invention. The propeller comprises at least one propeller blade, in the implementation of the adjustable propeller illustrated in FIG. 1 propeller includes four propeller blades only one 12 of which is visible in FIG. 1. However, other embodiments of the propeller of the present invention may be provided with more or fewer propeller blades. The FIG. 1 propeller 10 is preferably used on a floating vessel (not shown), such as a ship, although the propeller 10 of the present invention may also be used in other applications, such as for wind power plants (not shown).

The FIG. 1 propeller 10 comprises a boss 14 which in turn comprises a hub cylinder 16 and a hub body 18. Within the hub cylinder 16, a servo 20 is arranged comprising a piston 22 and a piston rod 24. The piston 22 divides the interior of the hub cylinder 16 into two chambers, namely an ahead pitch chamber 26 and an astern pitch chamber 28.

The boss 14 has a boss diameter Ø_{B} which is defined as the largest diameter of the boss 14 itself. As such, the propeller blades or any fixedly attached components thereof—as well as other elements protruding from the boss 14—should not be considered when determining the boss diameter Ø_{B}. In FIG. 1, this largest diameter is indicated as being located between the propeller blade 12 and a drive shaft 19 to which the propeller 10 is connected. However, in other embodiments of the propeller 10 the largest diameter may be located in other positions. Purely by way of example, the largest diameter may be located in a portion of the hub body 18 from which portion the propeller blades 12 extends. Again, purely by way of example, the boss diameter Ø_{B} may for supply vessels and cargo vessels range from 0.5 to 1.5 meters.

As may be gleaned from FIG. 1, the piston rod 24 comprises an ahead pitch duct 30 in fluid communication with the ahead pitch chamber 26 and an astern pitch duct 32 in fluid communication with the astern pitch chamber 28. As such, fluid may be conveyed through the aforementioned ducts 30, 32 to thereby change the position, along a first dimension L, of the piston 22. Thus, the piston 22 is displaceable along the first dimension L. In order to simplify the explanation of features and functions of the propeller 10 of the present invention, the expressions “ahead” and “astern” are introduced. The use of the expression “astern” in the description may be described by the fact that an astern displacement of the piston 22 is a displacement of the piston 22 away from the propeller blade 12 in the first dimension L. Consequently, an ahead displacement of the piston 22 is a displacement of the piston 22 towards the propeller blade 12 in the first dimension L.

The propeller 10 further comprises an adjusting member 34 located at a distance D in the first dimension from the piston 22. The adjusting member 34—which in the FIG. 1 embodiment is exemplified as a piston rod head 34—is fixedly attached to the piston rod 24, for instance by means of a bolt joint arrangement (not shown), and the piston rod 24 is in turn fixedly attached to the piston 22, also for instance by means of a bolt joint arrangement (not shown). As such, the piston rod head 34 is connected to the piston 22—the piston rod head 34 is in FIG. 1 in fact fixedly attached to the piston 22—such that a displacement along the first dimension L of the piston 22 results in a corresponding displacement of the piston rod head 34. As may be realized from FIG. 1, the piston rod head 34 is located in a hub cavity 36 of the hub body 18. It should be noted that although the piston rod head 34—in the embodiment of the propeller 10 illustrated in FIG. 1—is located at a distance D from the piston 22, the piston rod head 34 may in other embodiments of the present invention instead be located in close connection to the piston 22 and in some embodiments, the piston rod head 34 may in fact constitute a portion of the piston 22 (not shown).

Moreover, it should be noted that although the piston rod head 34—or more generalized the adjusting member—in the FIG. 1 embodiment is actuated by means of the servo 22, in other embodiments of the propeller 10 of the present invention, the adjusting member may instead be actuated by other means. Purely by way of example, the adjusting member may be actuated by an actuator (not shown) located outside of the propeller and the adjusting member may then be connected to the aforesaid actuator by means of a displacement transmission member—such as a rod—extending through at least a portion of the drive shaft 19 connected to the propeller 10. However, irrespective of how a displacement is imparted on the adjusting member, the displacement will result in a change in pitch of the propeller blade 12. How this is achieved is presented hereinbelow.

FIG. 1 also illustrates that the propeller 10 comprises an inlet duct 37 and an outlet duct 39 which ducts both are in fluid communication with the hub cavity 36, the inlet duct 37 and the outlet duct 39 being interconnected outside the boss for circulating a lubrication fluid through the hub cavity 36. The benefit of circulating a lubrication fluid through the hub cavity 36 is that the fluid may be inspected outside of the propeller 10 in order to detect possible defects in the hub cavity 36. Purely by way of example, should any part of the hub body 18, such as a sealing (not shown) between a propeller blade and the hub body 18, start leaking such that water is introduced in the hub cavity 36, water will enter the lubrication fluid circulated in the hub cavity 36 and the presence of water may be detected outside of the propeller, for instance by using a measuring device measuring the moisture content of the lubricant.

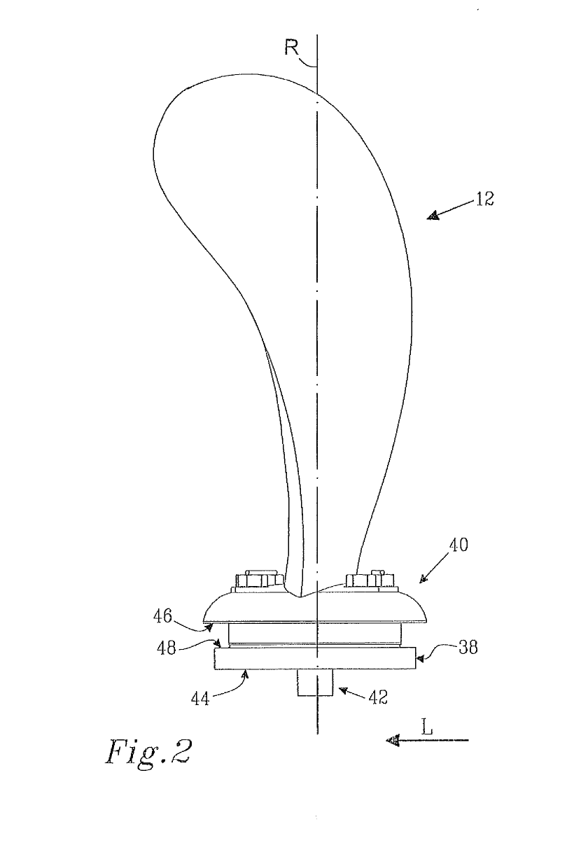

FIG. 2 illustrates the FIG. 1 propeller blade 12 fixedly attached to a blade root 38 (the blade root may also be referred to as a crank pin ring). The fixed attachment is preferably obtained by a bolt joint arrangement 40 which in FIG. 2 is constituted by six bolts. Moreover, the blade root 38 is provided with a pin 42 protruding from a bottom surface 44 of the blade root 38. In the FIG. 2 implementation of the blade root 38, the pin 42 and the remaining portion of the blade root 38 together form a unitary component although in other implementations of the blade root 38, the pin 42 may instead by a separate component which for instance is attached to the blade root 38 by means of threads (not shown) or a shrinkage fit arrangement (not shown).

As may be gleaned from FIG. 2, the propeller blade 12 comprises a circumferentially extending outer slide surface 46 adapted to slidably abut against a circumferentially extending outer surface of the hub body 18 (not shown in FIG. 2) whereas the blade root 38 comprises a circumferentially extending inner slide surface 48 adapted to slidably abut against a circumferentially extending inner surface of the hub body 18 (not shown in FIG. 2). As such, if the pin 42 is subjected to a displacement in the first dimension L, the propeller blade 12 will be subjected to a rotation about an axis of rotation R which axis is substantially perpendicular to the first dimension L.

In order to obtain the aforesaid slidable abutments, the outer slide surface 46 and the inner slide surface 48—as well as the corresponding surfaces of the hub body 18—are preferably made of materials which provide appropriate sliding characteristics. Purely by way of example, the outer slide surface 46 and the surfaces of the hub body 18 may be made of bronze. As for the inner slide surface 48, again purely by way of example, this may be made of bronze or steel.

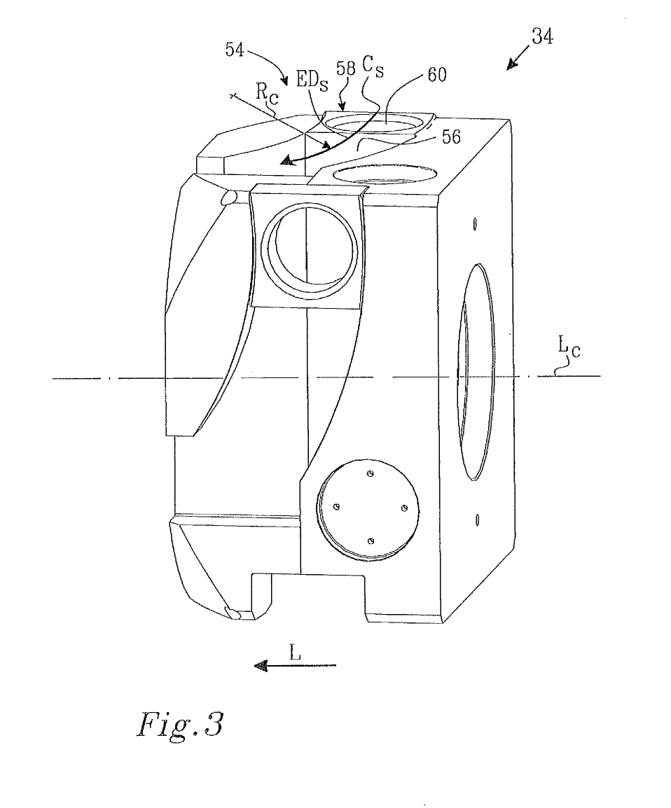

FIG. 3 illustrates the FIG. 1 piston rod head 34 which—as previously indicated—is comprised in the adjusting arrangement of the FIG. 1 propeller 10. As may be realized from FIG. 3, the piston rod head 34 illustrated therein comprises four slots, three of which are visible in FIG. 3, one for each one of the propeller blades of the propeller. When discussing the implementation of the slots hereinbelow, reference is made to the topmost slot in the FIG. 3 piston rod head 34 although it should be noted that the description hereinbelow generally also is applicable for each one of the three other slots.

As may be gleaned from FIG. 3, the piston rod head 34 comprises a slot 54 which in turn comprises a slot portion 56 with a slot centre Cₛ extending in a slot extension direction EDₛ which direction is arcuate with a radius of curvature R_{c}. FIG. 3 further illustrates that a block 58 is located in the slot 54 which block comprises an opening 60 adapted to receive the pin 42 of the blade root 38. The block 58 is slibably engaged with at least the slot portion 56 of the slot 54. The block 58 is preferably adapted to provide appropriate sliding characteristics in relation to a least the slot portion 56. To this end—purely by way of example—the block may be made of bronze. The block 58 and the pin 42 together form a control element 62 which is slidably engaged with at least said slot portion 56. However, in other embodiments of the present invention, the control element 62 may be constituted in other ways. Purely by way of example, the block 58 may in some implementations of the control element 62 be omitted such that the pin 42 in itself is slidably engaged with the slot portion 56. FIG. 3 also illustrates that the piston rod head 34 has a longitudinal centre line L_{c} extending parallel to the first direction L.

The slot 54 and the control element 62 together form a transformation arrangement 64 for transmitting a displacement—in the first dimension L—of the piston rod head 34 to a 30 change in pitch of the propeller blade 12. It should be noted that although—in the FIG. 2 and FIG. 3 implementation of the transformation arrangement 64—the slot is provided on the piston rod head 34 and the control arrangement 64 is associated with the propeller blade 12, this relation may in other implementations be the opposite such that the slot is provided on a member fixedly connected to the propeller blade 12—such as the blade root 38—whereas the control arrangement 64 may be associated with the piston rod head 34.

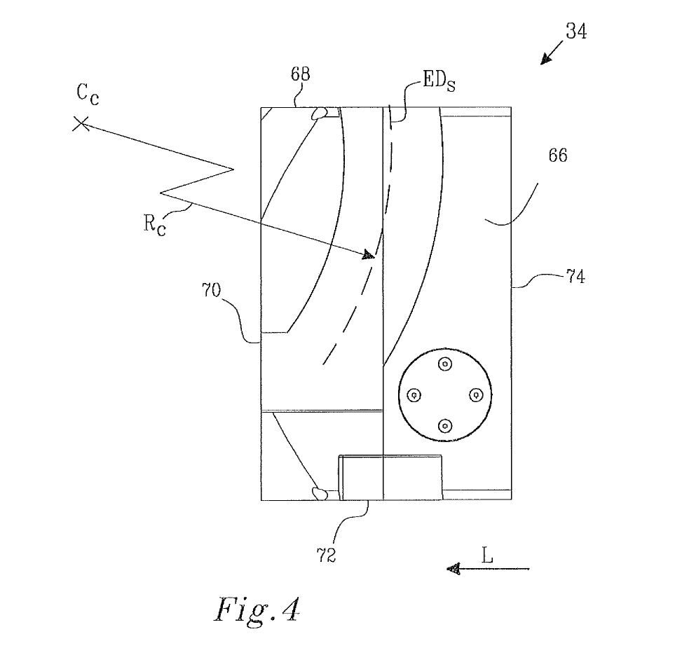

FIG. 4 illustrates a top view of the piston rod head 34 of the FIG. 1 propeller 10. As may be gleaned from FIG. 4, the slot extension direction EDₛ—which extension direction is arcuate—has a centre of curvature C_{c} which is located astern of the piston rod head 34 in the first dimension L. Moreover, the radius of curvature R_{c} is within the range of 0.2 to 0.7 times the boss diameter Ø_{B}. Preferably, the radius of curvature is within the range of 0.4 to 0.6, more preferably within the range of 0.45 to 0.55, times the boss diameter Ø_{B}. In fact, FIG. 4 illustrates a slot extension direction EDₛ with the most preferred radius of curvature R_{c}, namely 0.46 times the boss diameter Ø_{B}.

FIG. 4 further illustrates that the adjusting member—i.e. the piston rod head 34—comprises a substantially rectangular engagement region 66 comprising a first, 68 second 70, third 72 and fourth 74 edge. The first and third edges 68, 72 are located on opposite sides of the engagement region 66 and extend substantially parallel to the longitudinal dimension L. The second and fourth edges 70, 74 are located on opposite sides of the engagement region and extending substantially transversally to the longitudinal dimension L wherein the second edge 70 is located astern of the fourth edge 74. FIG. 4 further illustrates that the slot 54 extends in the engagement region 66 from the first edge 68 to the second edge 70.

It should be noted that the implementations of the parts of the transformation arrangement illustrated in FIGS. 3 and 4 are adapted to transform an ahead displacement of the adjusting member 34 to an ahead pitch—i.e. a pitch with increased ahead propulsion—of the propeller blades. However, other implementations of the transformation arrangement 64 may be designed so as to transform an ahead displacement of the adjusting member to an astern pitch of the propeller blades. Purely by way of example, and with reference to FIG. 4, such a function may be obtained by a transformation arrangement wherein its control element not shown in FIG. 4) is adapted to be located at the bottom of the adjusting member 34—i.e. close to the third edge 72—when the propeller blade associated with the slot illustrated in FIG. 4 is in a zero pitch position. A transformation arrangement adapted to transform an ahead displacement to an astern pitch preferably has a slot in the adjusting member which extends from the third edge to the fourth edge.

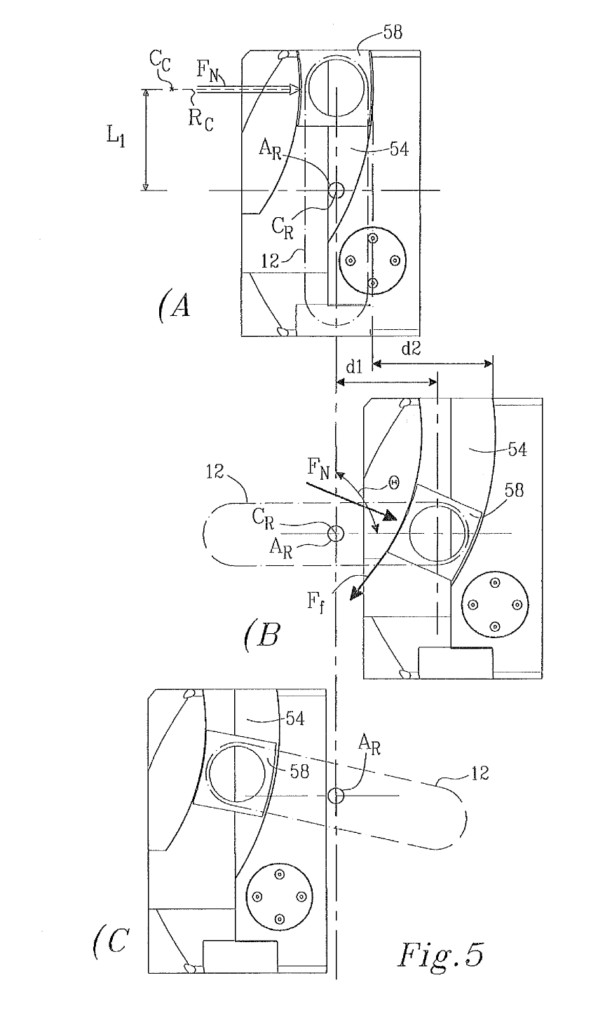

FIG. 5A illustrates the transformation arrangement 64 of the FIG. 1 propeller 10 when the propeller blade 12—indicated by dotted lines—is in a neutral, or zero pitch, position. As may be gleaned from FIG. 5A, when the propeller blade 12 is in the neutral position, the control element 62 is located in a top position—i.e. at a position with a largest distance from the longitudinal centre L_{c} of the piston rod head 34. When the control element 62 is in the FIG. 5A position, the transformation arrangement 64 will provide a maximum available torque Mₘₐₓ for the propeller blade 12 wherein the maximum available torque Mₘₐₓ is calculated as the normal force F_{N} between the control element 62 and the slot portion 56 multiplied by a distance L₁ from the action point of the normal force F_{N} to the centre of rotation C_{R} of the propeller blade 12 (i.e. the lever of the normal force F_{N}). As indicated in FIG. 5A, the centre of curvature C_{c} of the slot 54 is preferably located at substantially the same level as the normal force F_{N}—i.e. at substantially the lever L₁ in a direction perpendicular to the centre of rotation C_{R} of the propeller blade 12.

FIG. 5B illustrates the transformation arrangement 64 when the propeller blade 12 is approaching a feathering position. In the implementation of the propeller blade illustrated 20 in FIG. 5A, the feathering position is obtained when the pitch angle θ reaches 90°.

As may be gleaned from FIG. 5B, the control element 62 has now been displaced rearwardly—in the first dimension L—with a first distance d₁. In order to achieve this rearward displacement, the piston rod head 34 has been displaced a second distance d₂ which second distance d₂ is larger that the first distance d₁ and this difference between the first and second distance is occasioned by the arcuate shape of the slot portion 56.

Moreover, FIG. 5B illustrates that, since the slot portion 56 is arcuate such that its slot centre has an extension with a radius of curvature R_{c} in the interval as defined hereinabove, the control element 62 is less prone to tilt in relation to the slot portion 56 as compared to a transformation arrangement of the previous type including a rectilinear slot portion (not show). As may be realized by a person skilled in the art, the tilt may result in large contact forces resulting in large friction forces between the control element and the slot portion and these large friction forces may in turn result in that the control element gets stuck in the slot portion when the piston rod head is imparted a displacement in the first dimension L. However, the risk of having the control element 62 locked to the slot portion 56 is significantly reduced when using a slot portion 56 having a radius of curvature within the interval of the present invention.

FIG. 5B also illustrates an unexpected effect of providing the slot portion 56 with a radius of curvature within the range of 0.2 to 0.7 times the boss diameter Ø_{B}, namely that even when the propeller blade 12 is approaching a feathering position, the transformation arrangement 64 will impart a torque on the propeller blade 12. This is since the normal force F_{N} imparted on the control element 62 from the slot portion 56 will form an angle with the first dimension L. As such, even though the point of application of the normal force F_{N} on the control element 62 is located close to—or even on—an axis extending parallel to the first dimension L and intersecting the centre of rotation C_{R} of the propeller blade 12, the normal force F_{N} will nevertheless result in a torque—i.e. a moment around a axis of rotation A_{R} extending out of the plane in FIG. 5B, which axis A_{R} is located at the centre of rotation C_{R} of the propeller blade 12. As may be gleaned from FIG. 5B, the same reasoning applies for a friction force F_{f} imparted on the control element 62 from the slot portion 56, i.e. the friction force F_{f} will also result in an appropriately large torque irrespective of the position of the control element 62 in relation to the slot portion 56.

FIG. 5C illustrates the FIG. 5A transformation arrangement 64 wherein the propeller blade 12 is in an astern pitch position. As may be realized by a person skilled in the art, the reasoning as regards the torque obtained from the normal force F_{N} and the friction force F_{f} imparted on the control element 62 will apply mutatis mutandis for the position illustrated in FIG. 5C.

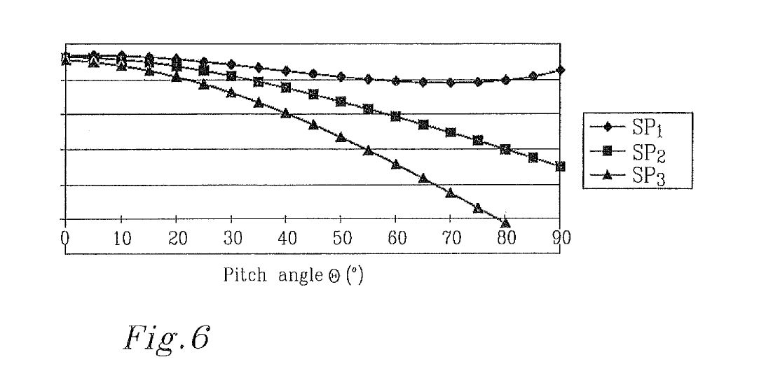

FIG. 6 is a graph illustrating the available torque Mₐᵥₐᵢₗ avail as a function of the pitch angle θ of the propeller blade 12 for three different implementations of the slot portion 56. The available torque Mₐᵥₐᵢₗ is in FIG. 6 normalized by the maximum available torque Mₘₐₓ. In FIG. 6, the three different implementations of the slot portion 56 are denominated SP₁, SP₂ and SP₃, respectively, wherein the first slot portion implementation SP₁ has a slot extension direction EDₛ with a radius of curvature R_{c} of approximately 0.35 times the boss diameter ØB, the second slot portion implementation SP₂ has a radius of curvature R_{c} of approximately 0.60 times the boss diameter ØB and the third slot portion implementation SP₃ has an infinite radius of curvature, i.e. the third slot portion implementation SP₃ is rectilinear.

As may be gleaned from FIG. 6, an implementation of the transformation arrangement 64 with the third slot portion implementation SP₃ will not be able to impart a torque on the propeller blade 12 if the pitch angle θ exceeds a certain threshold angle which threshold angle is smaller than 90° (approximately 80° in FIG. 6). However, for a transformation arrangement 64 with the first or the second portion implementation SP₁, SP₂ it is actually possible to impart a torque on the propeller blade 12 even if the pitch angle θ equals, or even exceeds, 90°. As may be realized from FIG. 6, the first slot portion implementation SP₁ will provide that a high torque may be imparted on the propeller blade 12 for the whole range from 0 to 90° of the pitch angle θ. Moreover, the second slot portion implementation SP₂ will provide a torque which decreases as the pitch angle θ increases. However, as compared to the first slot portion implementation SP₁, the second slot portion implementation SP₂ has the benefit of requiring a shorter hub body 18, i.e. a hub body 18 having a smaller extension in the first dimension L.

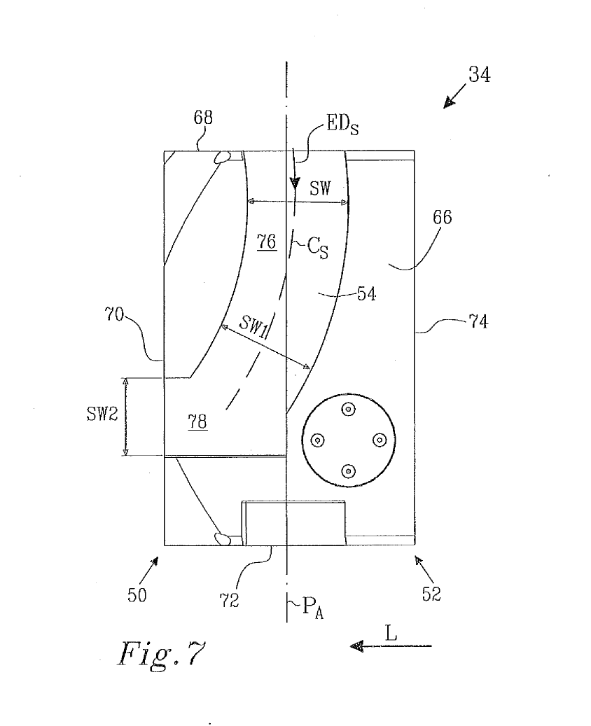

FIG. 7 illustrates an implementation of a piston rod head 34—or adjusting member. As may be gleaned from FIG. 7, the piston rod head 34 comprises a first piston rod head member 50 and a second piston rod head member 52 wherein the first 50 and second 52 rod head members are fixedly attached to one another—preferably by means of a bolt joint arrangement (not shown in FIG. 7)—and the members abut against each other in an abutment plane P_{A} which extends substantially perpendicularly to the first dimension L. It should also be noted that each one of the first piston rod head member 50 and a second piston rod head member 52 comprises a portion of the slot 54. As for the piston rod head 34 illustrated in FIG. 4, the FIG. 7 piston rod head 34 comprises a substantially rectangular engagement region 66 comprising a first, 68 second 70, third 72 and fourth 74 edge.

Moreover, FIG. 7 illustrates that the centre Cₛ of the slot 54 extends in a slot extension direction EDₛ from the first edge 68 to the second edge 72. The slot has a width S_{W} extending perpendicularly to the slot extension direction EDₛ. The slot comprises a first slot portion 76 and a second slot portion 78 wherein the second slot portion 78 is located downstream of the first slot portion 76 in the slot extension direction EDₛ. The first slot portion has a first slot width S_{w}, and the second slot portion has a second slot width S_{w2} wherein the second slot width S_{w2} is large enough to accommodate the pin 42 of the blade root 38. As may be realized from FIG. 7, the second slot portion 78 is—in the implementation illustrated therein—substantially rectangular.

Some of the advantages of having a piston rod head 34 which is constituted by two parts or members, as well as having the wider second slot portion 78, are explained in the following. First of all, it should be noted that the separation of the piston rod head into two portions are useful in a propeller assembling procedure—and in particular in a transformation arrangement assembly part of that procedure—a few steps of which are discussed below.

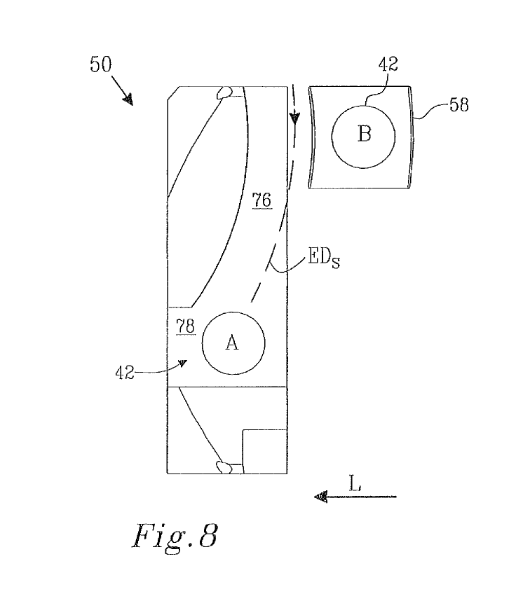

FIG. 8 illustrates the first piston rod head member 50 when the transformation arrangement 64 is in a pre-assembly position. As such, the first piston rod head member 50 is in FIG. 8 not attached to the second piston rod head member 52. In a first step of assembling the transformation arrangement, the pin 42 of the blade root 38 is introduced in the second slot portion 78. This is generally achieved by imparting an astern displacement in the first dimension L on the first piston rod head member 50 while the pin 42 remains stationary in relation to the propeller 10. The position of the pin 42 relative to the first piston rod head member 50 is indicated by the letter A in FIG. 8.

Next, the blade root 38—and possibly also the propeller blade 12 if this has already been attached to the blade root 38—is imparted a rotation such that pin 42 will be conducted 20 through the second slot portion 78 and at least a portion of the first slot portion 76 such that the pin 42 is located close to the first edge 68 of the first piston rod head member 50.

If the control element 62—in addition to the pin 42 also comprises a block 58, the first piston rod head member 50 is—in a third step—preferably moved even further astern in the first dimension L such that the block 58 may be connected to the pin 42, as indicated by letter B in FIG. 8. Then—in a fourth step—the first piston rod head member 50 is preferably moved astern in the first dimension L such that at the control element 62 is adjacent to the first piston rod head member 50. However, and as may be realized by a person skilled in the art, if the control element 62 is being constituted by only a pin 42, this third and fourth steps may be omitted.

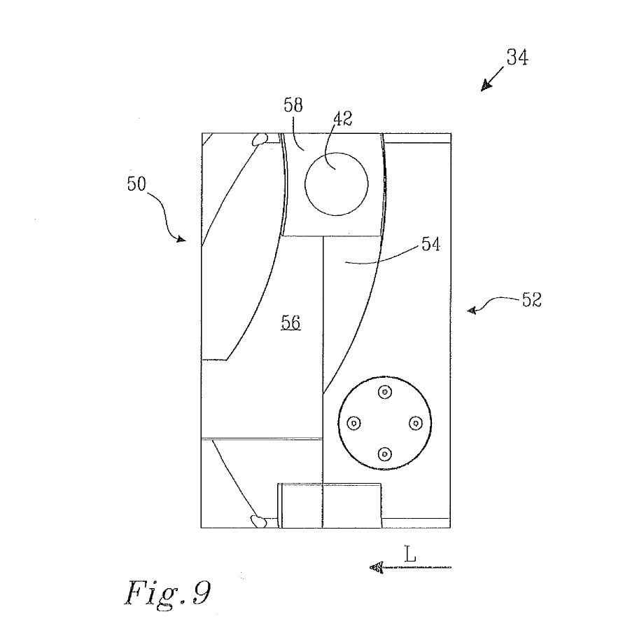

Then, and as is illustrated in FIG. 9, the second piston rod head member 52 is displaced towards the first piston rod head member 50 such that the slot 54 is formed. The first and second piston rod head member 50, 52 are then attached to one another, preferably by 35 means of a bolt joint arrangement (not shown in FIG. 9).

By the steps of the assembly procedure above, the control element 62 is now located in the slot 54 and the control element 62 is slidably engaged with at least a slot portion 56 of the slot 54. It should be noted that although the steps hereinabove have been described 5 for only transformation arrangement 64, for a propeller 10 comprising a plurality of propeller blades, and which thus generally comprises a plurality of transformation arrangements 64, the steps as defined hereinabove may be performed substantially simultaneously for each one of the transformation arrangements 64.

It should be realized that the present invention is not limited to the embodiments described hereinabove and illustrated in the drawings. Rather, a person skilled in the art will realize that many changes and modifications may be performed within the scope of the appended claims.

1. A propeller comprising a boss with a boss diameter and at least one propeller blade, said propeller further comprising an adjusting member, adapted to be displaced along a first dimension, and a transformation arrangement connecting said adjusting member to said propeller blade such that a displacement, in said first dimension, of said adjusting member results in a change in the pitch of said propeller blade, said transformation arrangement comprising a slot comprising a slot portion with a slot center extending in a slot extension direction which direction is arcuate with a radius of curvature, said transformation arrangement further comprising a control element slidably engaged with at least said slot portion wherein said radius of curvature is within the range of 0.2 to 0.7 times said boss diameter and that said adjusting member comprises a piston rod head, wherein said slot is provided on said piston rod head and said piston rod head comprises a first piston rod head member and a second piston rod head member, each one of said first and second piston members comprising a portion of said slot and said first and second rod head member abut against each other in an abutment plane extending substantially perpendicularly to said first dimension.

2. The propeller according to claim 1, wherein said radius of curvature is within range of 0.4 to 0.6, preferably within the range of 0.45-0.55, times said boss diameter.

3. The propeller according to claim 1, wherein said propeller comprises a servo located in said boss, said servo comprising a piston which is displaceable along said first dimension, said piston being rigidly connected to said adjusting member.

4. The propeller according to claim 1, wherein said control element comprises a block and a pin, said block comprising a block opening and being slidably engaged with said slot, said pin engaging with said block opening.

5. The propeller according to claim 1, wherein said slot is associated with said adjusting member and at least a portion of said control element is rigidly connected to said propeller blade.

6. The propeller according to claim 3, wherein said adjusting member comprises a piston rod and a piston rod head, said piston rod being fixedly attached to said piston rod, wherein said slot is provided on said piston rod head.

7. The propeller according to claim 1, wherein said adjusting member comprises a substantially rectangular engagement region comprising a first, second, third, and fourth edge, said first and third edge being located on opposite sides of said engagement region and extending substantially parallel to said longitudinal dimension, said second and fourth edge being located on opposite sides of said engagement region and extending substantially traversal to said longitudinal dimension, said slot extending in said engagement region from said first edge to said second edge.

8. The propeller according to claim 6, wherein said slot extends in a slot extension direction from said first edge, said slot having a width extending perpendicularly to said slot extension direction, said slot comprising a first slot portion and a second slot portion wherein said second slot portion is located downstream of said first slot portion in said slot extension direction, said first slot portion having a first slot width and said second slot portion having a second slot width such that said second slot portion is adapted to accommodate at least one component of said control element.

9. The propeller according to claim 1, wherein said boss comprises a cavity in which at least a portion of said adjusting member is located, said propeller further comprising an inlet duct and an outlet duct which ducts both are in fluid communication with said cavity, the inlet duct and the outlet duct being interconnected outside the boss for circulating a lubrication fluid through said cavity.

10. The propeller according to claim 1, wherein said propeller comprises a plurality of propeller blades, each one of said plurality of propeller blades being provided with a corresponding transformation arrangement.

11. A vessel, wherein said vessel comprises a propeller according to claim 1.

12. A method for assembling a propeller comprising a boss with a boss diameter and at least one propeller blade comprising a blade root which in turn comprises a pin, said propeller further comprising an adjusting member, adapted to be displaced along a first dimension, and a transformation arrangement connecting said adjusting member to said propeller blade such that, after assembly, a displacement in said first dimension of said adjusting member results in a change in the pitch of said propeller blade, said adjusting member comprising a piston rod head which in turn comprises a first piston head member and a second piston rod head member, said first piston head member comprising a second slot portion, said boss comprising a cavity in which at least a portion of said adjusting member is located, said transformation arrangement comprising a slot comprising a first slot portion with a slot center extending in a slot extension direction which direction is arcuate with a radius of curvature within the range of 0.2 to 0.7 times said boss diameter, said transformation arrangement further comprising a control element slidably engaged with at least said first slot portion, said control element comprising said pin characterized on that said method comprises the steps of
introducing said first piston rod head member into said cavity;
introducing at said pin into said cavity;
rotating said blade root such that said pin is conducted through said second slot portion and at least a portion of said first slot portion;
introducing said second piston rod head member into said cavity, and
attaching together said first piston rod head member and said second piston rod head member to thereby form said first arcuate slot portion such that said pin is located between said first and second piston rod members in said first arcuate slot portion.

13. The method according to claim 12, wherein said control element further comprises a block adapted to be connected to said pin wherein the method further comprises the steps of;
moving said first piston rod head away from said pin;
connecting said block to said pin, and
moving said first piston rod head such that said control element is adjacent to said first piston rod head member.

14. The method according to claim 12, wherein said first piston rod head member and said second piston rod head member are attached together by means of a bolt joint arrangement.
